(19) United States
(12) Patent Application Publication
(10) Pub. No.: US 2014/0047260 A1
(43) Pub. Date: Feb. 13, 2014

(54) NETWORK MANAGEMENT SYSTEM, NETWORK MANAGEMENT COMPUTER AND NETWORK MANAGEMENT METHOD

(71) Applicant: Hitachi, Ltd., Tokyo (JP)

(72) Inventors: Tomoyuki IIJIMA, Tokyo (JP); Toshiaki SUZUKI, Hachioji (JP); Toshiaki TARUI, Sagamihara (JP)

(73) Assignee: Hitachi, Ltd., Tokyo (JP)

(21) Appl. No.: 13/954,361

(22) Filed: Jul. 30, 2013

(30) Foreign Application Priority Data
Aug. 8, 2012 (JP) JP 2012-176358

(51) Int. Cl. G06F 1/32

(52) U.S. Cl. CPC G06F 1/3287
USPC 713/324

(57) ABSTRACT

A network management system comprising: a network including a plurality of packet relay apparatuses; wherein the plurality of packet relay apparatuses include first packet relay apparatuses, second packet relay apparatuses, and third packet relay apparatuses located downstream of the first packet relay apparatuses and the second packet relay apparatuses, wherein each of the third packet relay apparatuses has a first path coupled to one of the first packet relay apparatuses to send and receive traffic and a second path coupled to one of the second packet relay apparatuses and being in a blocking state, a management computer includes: a state information collection unit for acquiring state information on the first to the third packet relay apparatuses; and a power management unit for selecting a candidate packet relay apparatus to be deactivated satisfying predetermined conditions based on the state information.

### CLAIM OF PRIORITY

The present application claims priority from Japanese patent application JP 2012-176358 filed on Aug. 8, 2012, the content of which is hereby incorporated by reference into this application.

### BACKGROUND

This invention relates to a management system, a management computer, and a management method for a network including a plurality of packet relay apparatuses.

To provide cloud services, a data center includes a large number of computers, storage apparatuses and packet relay apparatuses installed therein. In general, networks composed of a large number of packet relay apparatuses in data centers are trending toward large scale Layer 2 networks. The Layer 2 network is a system that transfers packets in accordance with destination MAC addresses of the packets; the packets are reachable to all of the packet relay apparatuses in the network. Because of this feature, careless coupling of packet relay apparatuses with Ethernet cables might cause a problem that a loop is created in which packets circulate around the loop to be amplified. To prevent this problem, the Layer 2 network usually uses STP (Spanning Tree Protocol). According to the STP, protocol packets are exchanged between packet relay apparatuses to determine a packet relay apparatus for a root node from a plurality of packet relay apparatuses to create a tree network with the root node at the top. Packets can be transmitted only through the paths forming the tree and cannot be transmitted through the other paths in a blocking state.

In the meanwhile, a network in a data center includes a large number of packet relay apparatuses installed therein and also requires a large number of cooling devices to cool the heat generated by the packet relay apparatuses. For this reason, the network in a data center tends to consume a huge electric power. Currently, to lower the power consumption in a packet relay apparatus, technology for power saving is being actively developed. For example, according to JP 2010448023 A, edge routers measure the traffic volume in the network and if the traffic volume is smaller than the capacity of a first core router, a second core router is shifted to a power saving mode and the edge routers update the routing table to transfer packets for the second core router to the first core router.

### SUMMARY

The power saving technology focusing on a single packet relay apparatus like the above-described JP 2010-148023 A, however, might be difficult in handling in practical use because of effect on the traffic flowing in the network. In the case of JP 2010-148023 A, when a packet relay apparatus is suddenly changed into a power saving mode and the packet throughput is lowered, packets transferred to the alternate packet relay apparatus might be lost without being processed at the alternate packet relay apparatus.

An object of this invention is to provide a network management system and a network management terminal that can reduce the power consumption in the network without serious effect on the traffic flowing in the network in the data center.

A representative aspect of this invention is as follows. A network management system comprising: a network including a plurality of packet relay apparatuses; and a management computer for managing the plurality of packet relay apparatuses, wherein the plurality of packet relay apparatuses include first packet relay apparatuses, second packet relay apparatuses, and third packet relay apparatuses located downstream of the first packet relay apparatuses and the second packet relay apparatuses, wherein each of the third packet relay apparatuses has a first path coupled to one of the first packet relay apparatuses to send and receive traffic and a second path coupled to one of the second packet relay apparatuses and being in a blocking state, wherein the management computer includes: a state information collection unit for acquiring state information on the first to the third packet relay apparatuses; and a power management unit for selecting a candidate packet relay apparatus to be deactivated satisfying predetermined conditions based on the state information as a first packet relay apparatus to be deactivated out of the first packet relay apparatuses which can be deactivated when using the second path in the blocking state to transmit the traffic, deactivating the first packet relay apparatus to be deactivated, releasing the second path in the blocking state between the third packet relay apparatus and the second packet relay apparatus for the first packet relay apparatus to switch sending and receiving the traffic to the second path.

Accordingly, this invention achieves reduction in power consumption in a network without effect on the traffic in the network by switching a path carrying traffic into a path in a blocking state to deactivate an upstream packet relay apparatus.

### BRIEF DESCRIPTION OF THE DRAWINGS

FIG. 1 is a block diagram illustrating a topology of a network including a network management terminal and a plurality of packet relay apparatuses according to an embodiment of this invention.

FIG. 2 is a block diagram illustrating a general configuration of a packet relay apparatus according to the embodiment of this invention.

FIG. 3 is a drawing illustrating an example of the configuration information in a packet relay apparatus according to the embodiment of this invention.

FIG. 4 is a drawing illustrating an example of the state information in a packet relay apparatus according to the embodiment of this invention.

FIG. 5 is a block diagram illustrating a configuration of the network management terminal according to the embodiment of this invention.

FIG. 6 is a drawing illustrating an example of the state information database according to the embodiment of this invention.

FIG. 7 is a screen image illustrating an example of the GUI shown on the display device of the network management terminal according to the embodiment of this invention.

FIG. 8 is a sequence diagram illustrating a process flow for the network management terminal to reduce the power consumption in the network to be managed according to the embodiment of this invention.

FIG. 9 is a flowchart illustrating an example of processing of the network management terminal according to the embodiment of this invention.

FIG. 10 is a flowchart illustrating an example of processing of the network management terminal according to a modified embodiment of this invention.

FIG. 11 is a flowchart illustrating an example of processing of the network management terminal according to another modified embodiment of this invention.

FIG. 12 is a flowchart illustrating an example of processing of the network management terminal according to another modified embodiment of this invention.

### DETAILED DESCRIPTION OF THE EMBODIMENTS

Hereinafter, an embodiment of this invention is described with reference to the accompanying drawings.

(A1) Network Topology

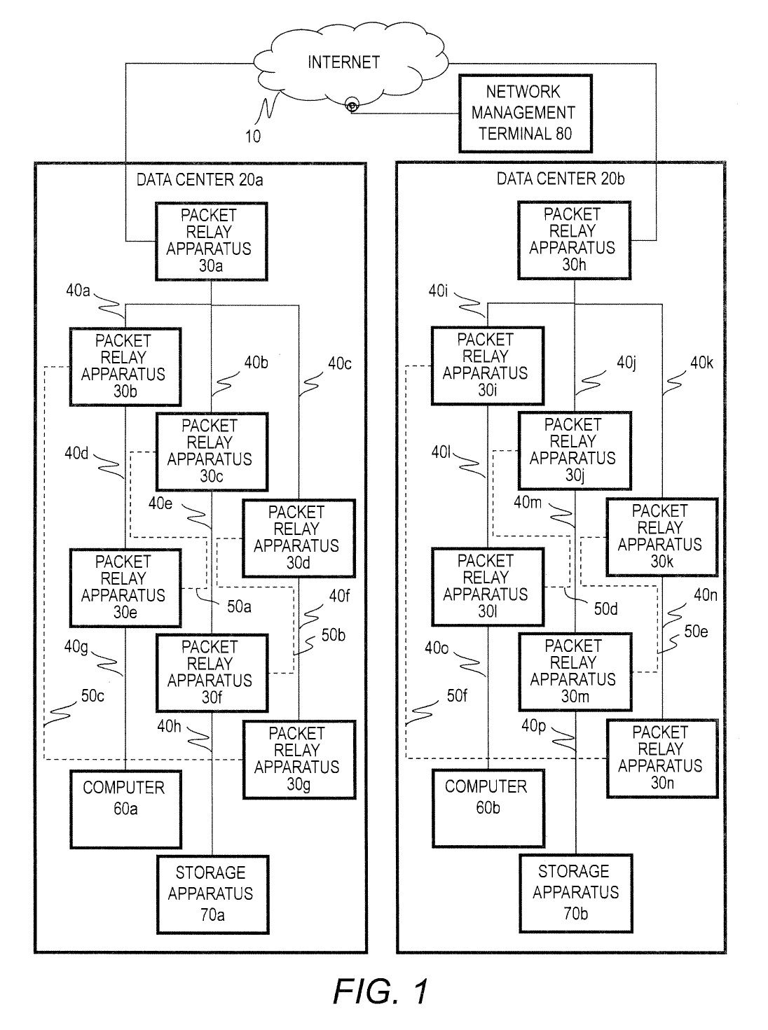

FIG. 1 illustrates an embodiment of this invention and is a block diagram illustrating a topology of a network including a network management terminal and a plurality of packet relay apparatuses.

In FIG. 1, data centers 20a and 20b providing two sites are coupled via the Internet 10. In the data centers 20a and 20b, Layer 2 networks are provided with packet relay apparatuses 30a to 30g and packet relay apparatuses 30h to 30n, respectively. The packet relay apparatuses are generally denoted by a reference numeral 30. Paths 40a to 40h are generally denoted by a reference numeral 40 and paths 50a to 50f are generally denoted by a reference numeral 50.

These networks uses STP (Spanning Tree Protocol); in the case of the data center 20a, the packet relay apparatus 30a is selected as a root packet relay apparatus (hereinafter, root bridge) and in the case of the data center 20b, the packet relay apparatus 30h is selected as a root bridge.

The STP creates a tree network in which the root bridge is the top to avoid a loop in the paths. The paths 40a to 40p forming the trees are denoted by solid lines in FIG. 1 and packets are transmitted only through these paths.

In the case of data center 20a, the paths 40a to 40h form the tree. It should be noted that, in each packet relay apparatus 30, the port coupled to a path 40 through which upstream packets are transmitted is called a root port.

The paths that are not included in the trees are paths 50a to 50f denoted by broken lines in FIG. 1; these paths 50 are physically coupled but are in a blocking state in which transmission of packets is blocked. In the case of the data center 20a, the paths 50a to 50c are in the blocking state. In each packet relay apparatus 30, the port coupled to a path in the blocking state is called a blocking port.

These networks are managed by a network management terminal (management computer) 80; configuration of the packet relay apparatuses 30 and acquisition of information on the packet relay apparatuses 30 are performed by this network management terminal 80. The network management terminal 80 can communicate with each packet relay apparatus 30 in the data centers 20a and 20b via the Internet 10.

In the data centers 20a and 20b, a large number of computers and storage apparatuses are installed in addition to the packet relay apparatuses 30. In FIG. 1, computers 60a and 60b are installed to send and receive information via the networks to perform desired processing. Furthermore, storage apparatuses 70a and 70b are installed to store data via the networks.

The aforementioned apparatuses are each assigned a MAC address and an IP address to be located with these addresses in the network.

Hereinafter, described in detail is a method to reduce the power consumed by a network without serious effect on the traffic in the network, taking a case of the network constructed in the data center 20a or 20b as described above.

The network topology, the number of packet relay apparatuses, the number of computers 60, and the number of storage apparatuses 70 are not limited to those shown in the example of FIG. 1 but can employ different conditions as appropriate.

(A2) Configuration of Packet Relay Apparatus

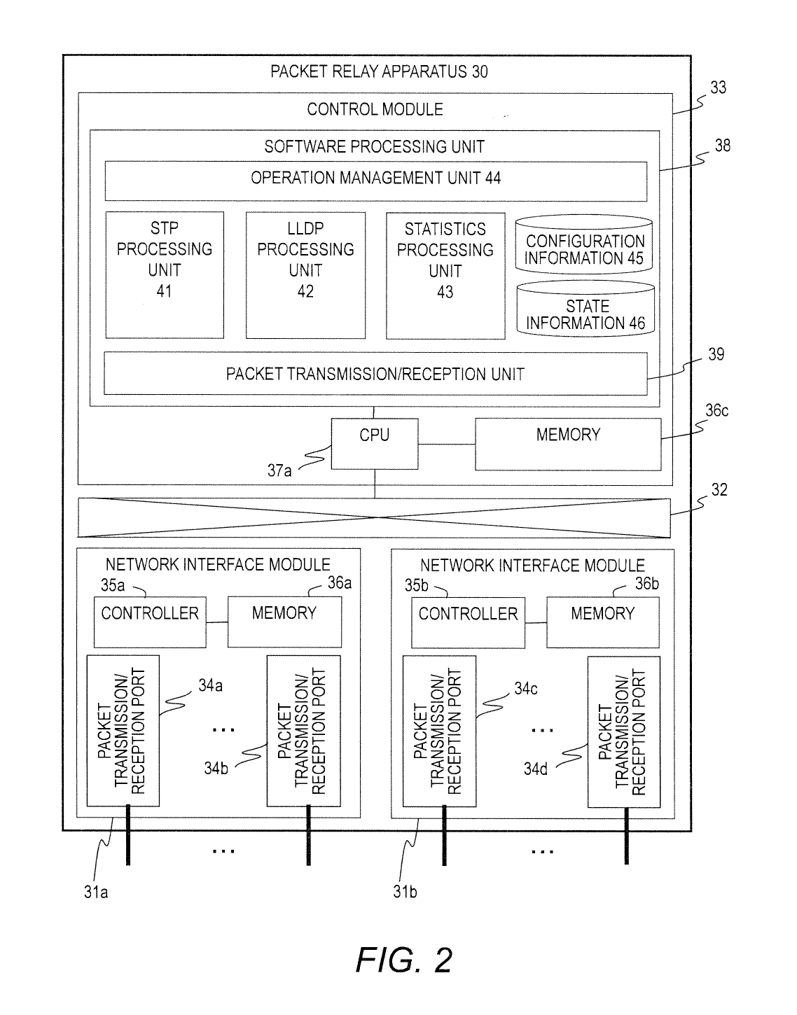

FIG. 2 is a block diagram illustrating a general configuration of a packet relay apparatus 30. The packet relay apparatus 30 includes a plurality of network interface modules 31a and 31b, a switching module 32, and a control module 33. Hereinafter, the network interface modules are generally denoted by a reference numeral 31.

The network interface modules 31 include a plurality of packet transmission/reception ports 34a to 34d, controllers 35a and 35b, and memories 36a and 36b. To the packet transmission/reception ports 34a to 34d, Ethernet cables are physically coupled. Hereinafter, the packet transmission/reception ports are generally dented by a reference numeral 34; the controllers are generally denoted by a reference numeral 35; and the memories are generally denoted by a reference numeral 36.

The controller 35 in the network interface module 31 analyzes each packet received from the packet transmission/reception port 34 to identify the destination of the packet. If the destination is a different apparatus, the controller 35 locates the network interface module 31 and the packet transmission/reception port 34 of the destination apparatus and transfers the packet to the switching module 32.

On the other hand, if the destination of the packet is the same apparatus including the controller 35, the controller 35 determines that the destination of the packet is the control module 33 and transfers the packet to the switching module 32. The memory 36 functions as a buffer to temporarily store the packet to be sent or received through the packet transmission/reception port 34.

Upon receipt of a packet, the switching module 32 sends the packet to the network interface module 31 or the control module 33 in accordance with the instruction of the controller 35 concerning the packet.

The control module 33 includes a memory 36c and a CPU 37a. The memory 36c holds a program for a software processing unit 38 and the CPU 37a executes the program in the memory 36c to function as the software processing unit 38.

The software processing unit 38 includes functional units of a packet transmission/reception unit 39, an STP processing unit 41, an LLDP (Link Layer Discovery Protocol) processing unit 42, a statistics processing unit 43, an operation management unit 44 and data of configuration information 45 and state information 46. The packet transmission/reception unit 39 controls over reception of packets sent to the local apparatus and transmission of packets created in the software processing unit 38 to be sent to remote apparatuses.

The STP processing unit 41 controls over transmission and reception of STP packets between packet relay apparatuses 30. The STP processing unit 41 transmits and receives STP packets to determine the role of the local apparatus in the STP. If the STP processing unit 41 determines that the local apparatus is a root bridge, it records the determination in the configuration information 45 and functions as a root bridge thereafter.

If the STP processing unit 41 determines that the local apparatus is not a root bridge (hereinafter, a non-root bridge), it records the determination in the configuration information 45 and functions as a non-root bridge thereafter. The STP processing unit 41 transmits and receives STP packets to also determine the STP roles of the packet transmission/reception ports 34 in the local apparatus.

If the local apparatus is a root bridge, the STP processing unit 41 determines that all the packet transmission/reception ports 34 are designated ports. The STP processing unit 41 records the determination on all the packet transmission/reception ports 34 in the configuration information 45 and makes the packet transmission/reception ports 34 function as designated ports thereafter.

If the local apparatus is a non-root bridge, the STP processing unit 41 determines that the packet transmission/reception ports 34 coupled to the path to the root bridge are root ports. The STP processing unit 41 records the determination on the root ports in the configuration information 45 and makes the packet transmission/reception ports 34 function as root ports thereafter. Furthermore, the STP processing unit 41 determines that the packet transmission/reception ports 34 which are not coupled to the path to the root bridge are designated ports. The STP processing unit 41 records the determination on the designated ports in the configuration information 45 and makes the packet transmission/reception ports 34 function as designated ports thereafter.

The STP processing unit 41 determines that the packet transmission/reception ports 34 to cause a loop are blocking ports. The STP processing unit 41 records the information on the blocking ports in the configuration information 45 and makes the packet transmission/reception ports 34 function as blocking ports thereafter.

The LLDP processing unit 42 controls over transmission and reception of LLDP packets between packet relay apparatuses 30. The LLDP processing unit 42 transmits and receives LLDP packets to recognize the apparatuses (neighboring nodes) coupled to the packet transmission/reception ports 34 of the local apparatus. The LLDP processing unit 42 that recognizes neighboring nodes coupled from the packet transmission/reception ports 34 records information on the neighboring nodes in the state information 46.

The statistics processing unit 43 measures and manages various numerical values in the packet relay apparatus 30. For example, it monitors transmitted traffic volume and received traffic volume at each packet transmission/reception port 34 to record statistical information in the state information 46. The statistics processing unit 43 counts the sessions maintained in the packet relay apparatus 30 to record it in the state information 46. The statistics processing unit 43 also counts the flows being processed in the packet relay apparatus 30 to record it in the state information 46. The statistics processing unit 43 measures the traffic volumes, the number of sessions, and the number of flows at predetermined intervals or in response to a request from an external to record them in the state information 46 as statistics information.

The operation management unit 44 sets configuration of the packet relay apparatus 30 based on a configuration request sent from the network management terminal 80. The operation management unit 44 records details of the configuration in the configuration information 45. The configuration request includes, for example, a request to start STP operation and a request to stop STP operation. The operation management unit 44 also acquires requested information from the state information 46 based on a state information reference request sent from the network management terminal 80. The operation management unit 44 returns the information acquired from the state information 46 to the network management terminal 80. The state information reference request from the network management terminal 80 requests, for example, the STP role of the packet relay apparatus 30 determined to enable the STP.

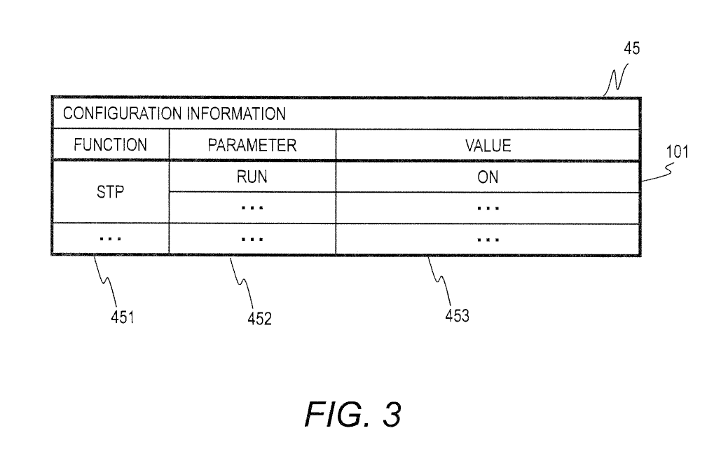

The configuration information 45 stores configuration information on the packet relay apparatus 30. FIG. 3 is a drawing illustrating an example of the configuration information 45 in a packet relay apparatus 30. The configuration information 45 includes functions 451 in the packet relay apparatus 30, parameters 452, and values 453 set to the parameters 452. For example, the line 101 in FIG. 3 indicates that the STP in the function 451 is working at a value 453=ON for the parameter 452=RUN.

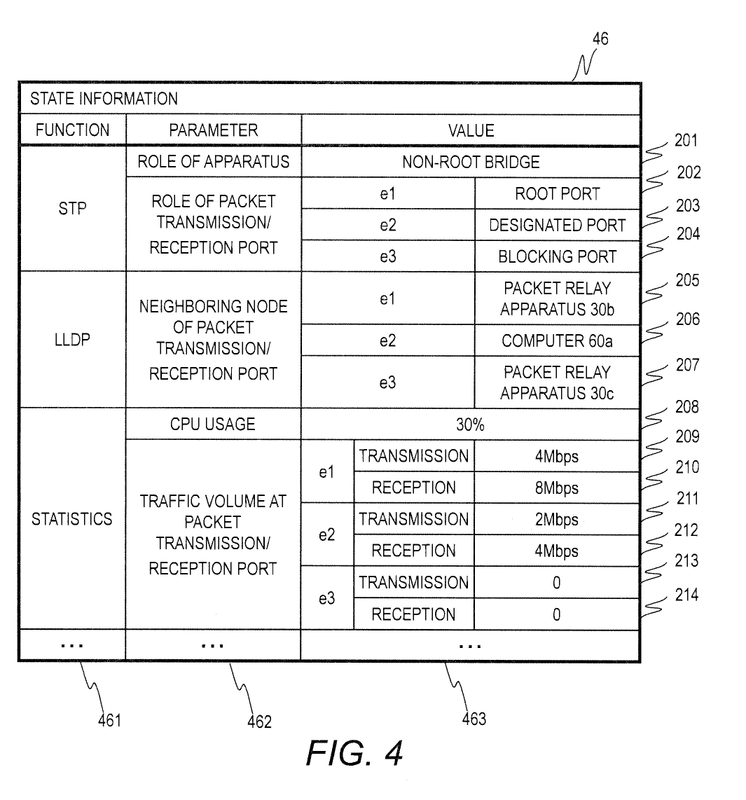

The state information 46 stores information on states of the packet relay apparatus 30. FIG. 4 is a drawing illustrating an example of the state information 46 in a packet relay apparatus 30. The state information 46 includes functions 461 of the packet relay apparatus 30, parameters 462, and values 463 set to the parameters 462. For example, the line 201 in FIG. 4 indicates that, in the function 461=STP, the parameter 462 “role of apparatus” is determined to be the value 463 “non-root bridge”. The lines 202 to 204 indicate that, in the function 461=STP, the parameter 462=roles of ports are port e=root port, port e2=designated port, and e3=blocking port. The lines 205 to 207 indicate that, in the function 461=LLDP, the parameter 462=neighboring nodes of ports are the packet relay apparatus 30b coupled to the port e1, the computer 60a coupled to the port e2, and the packet relay apparatus 30b coupled to the port e3. The same applies to the statistics on the line 208 and the subsequent lines, which store values about the CPU usage and the traffic volumes.

(A3) Configuration of Network Management Terminal

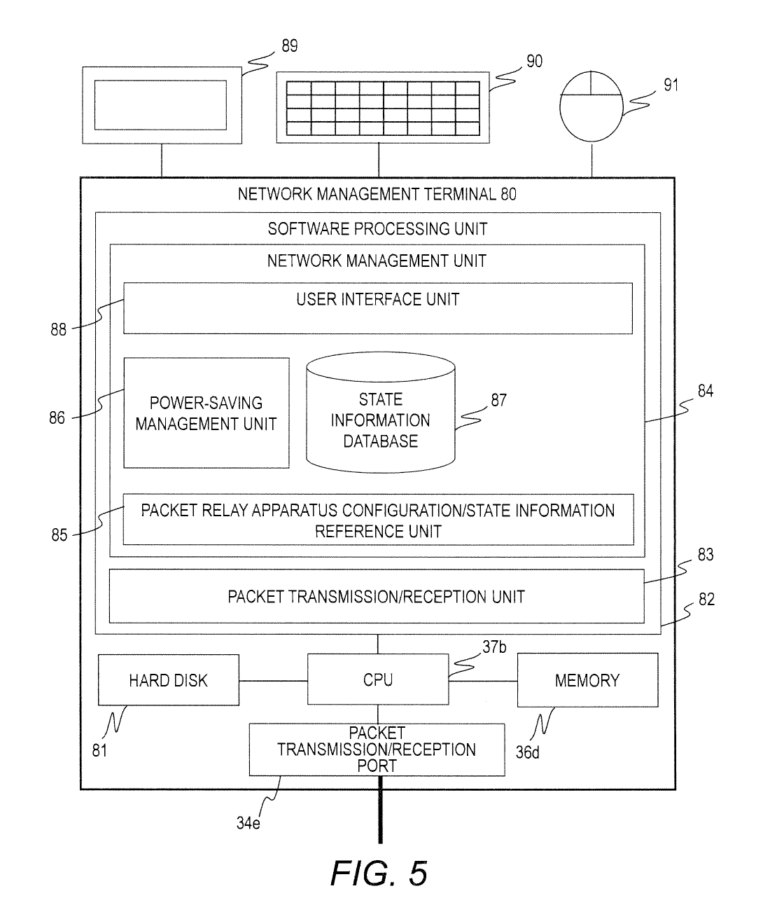

FIG. 5 is a block diagram illustrating a configuration of the network management terminal 80. The network management terminal 80 is made up of a general-purpose computer and includes a packet transmission/reception port 34e, a hard disk 81, a memory 36d, and a CPU 37b. The hard disk 81 holds a program for a software processing unit 82 and the CPU 37b executes the program for the software processing unit 82 to function as a packet transmission/reception unit 83 and a network management unit 84.

The packet transmission/reception unit 83 controls over transmission and reception of packets through the packet transmission/reception port 34e.

The network management unit 84 is an application for functioning as a frontend to manage packet relay apparatuses 30 and includes a packet relay apparatus configuration/state information reference unit 85, a power-saving management unit 86, a state information database 87, and a user interface unit 88.

The packet relay apparatus configuration/state information reference unit 85 creates configuration/state information reference request messages in accordance with requests of the power-saving management unit 86 and sends them to packet relay apparatuses 30. A configuration request message requests, for example, shut-down of the packet relay apparatus 30. A state information reference request message requests, for example, the STP role of the packet relay apparatus 30.

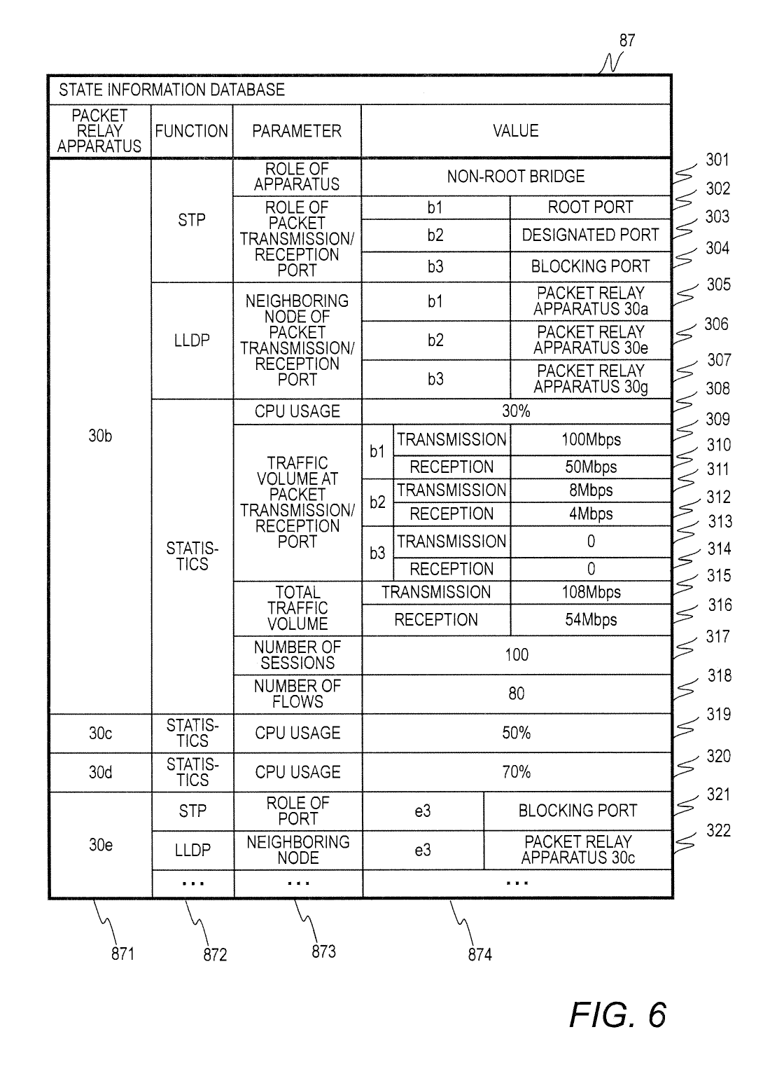

The power-saving management unit 86 stores results obtained from the packet relay apparatus configuration/state information reference unit 85 in the state information database 87. The state information database 87 holds the state information 46 on each packet relay apparatus 30, for all of the packet relay apparatuses 30 to be managed by the network management terminal 80. FIG. 6 is a drawing illustrating an example of the state information database 87. The state information database 87 includes packet relay apparatuses 871 for storing identifiers (unique values) of packet relay apparatuses 30, functions 872 of the packet relay apparatuses 30, parameters 873, and values 874 set to the parameters 873. For example, FIG. 6 stores CPU usages, traffic volumes (transmission traffic volumes and reception traffic volumes), the number of sessions, and the number of flows for all the packet relay apparatuses 30. The network management terminal 80 uses the information stored in this state information database 87 to create a network that consumes less power. The creating a network will be described later.

The user interface unit 88 shows a GUI (Graphical User Interface) to manage packet relay apparatuses 30 on a display device 89 to receive various instructions of the network administrator through a keyboard 90 or a mouse 91 operated by the network administrator.

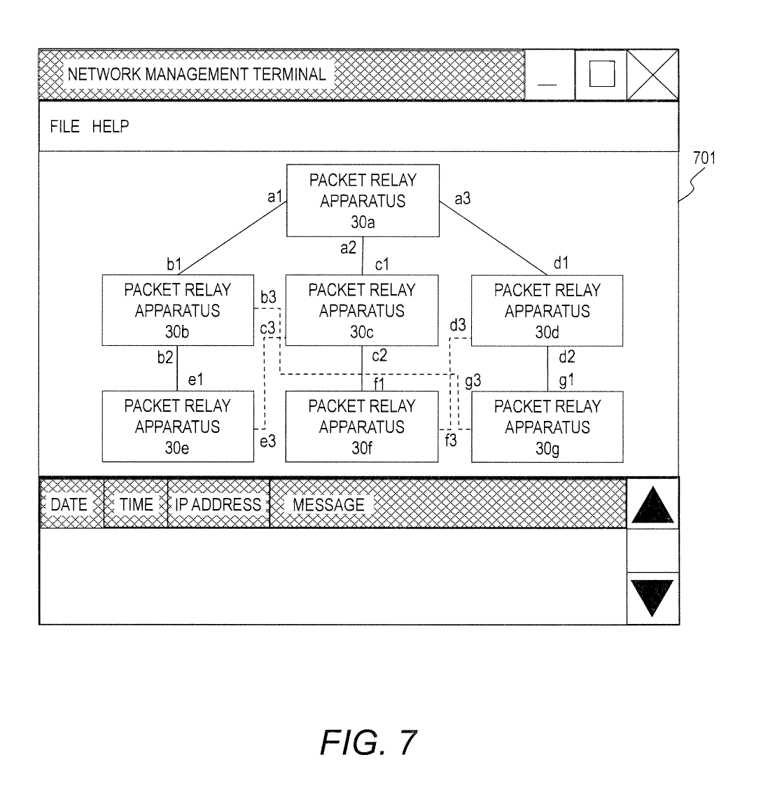

FIG. 7 is a screen image illustrating an example of the GUI shown on the display device 89 of the network management terminal 80. In the pane 701 in the middle of the GUI, the topology of the network to be managed by the network management terminal 80 is depicted with icons representing packet relay apparatuses 30 and Ethernet cables. This drawing teaches the network administrator the current network topology. The example of FIG. 7 shows the topology of the network in the data center 20a.

In FIG. 7, the paths forming a tree are denoted by solid lines and the paths coupling blocking ports are denoted by broken lines. The reference signs a1 to g2 in the drawing represent ports of the packet relay apparatuses 30a to 30g. It should be noted that the network to which this invention is applied includes a plurality of packet relay apparatuses 30 on the first level each coupled to the root bridge with its root port and a plurality of packet relay apparatuses 30 on the second level each coupled to the first level with both of its root port and a blocking port.

In FIG. 7 (FIG. 1), the packet relay apparatuses 30b, 30c and 30d constitute the first level; the root ports b1, c1, and d1 are coupled to the root bridge of the packet relay apparatus 30a.

The packet relay apparatuses 30e, 30f, and 30g constitute the second level and the root ports e1, f1, g1 are coupled to the designated ports b2, c2, and d2 of the packet relay apparatuses 30 on the first level. The packet relay apparatus 30e is disposed downstream of the packet relay apparatus 30b, the packet relay apparatus 30f is disposed downstream of the packet relay apparatus 30c, and the packet relay apparatus 30g is disposed downstream of the packet relay apparatus 30d, to form the first level and the second level. The blocking ports of the second level and the blocking ports of the first level are coupled as shown by the broken lines in the drawing. That is to say, the blocking port e3 of the packet relay apparatus 30e on the second level is coupled to the blocking port c3 of the packet relay apparatus 30c on the first level, the blocking port f3 of the packet relay apparatus 30f on the second level is coupled to the blocking port d3 of the packet relay apparatus 30d on the first level, and the blocking port g3 of the packet relay apparatus 30g on the second level is coupled to the blocking port b3 of the packet relay apparatus 30b on the first level.

The designated ports of the packet relay apparatuses 30e, 30f, and 30g on the second level are coupled to other nodes such as the computer 60, as shown in FIG. 1.

As described above, the packet relay apparatuses 30 on the first level, which are downstream of the root bridge, are coupled to the root bridge with the root ports. The packet relay apparatuses 30 on the second level are coupled to upstream packet relay apparatuses 30 on the first level with the root ports and blocking ports, where the root port and the blocking port of each packet relay apparatus 30 on the second level are coupled to different packet relay apparatuses 30 on the first level. As to the path 50 coupling blocking ports shown in FIG. 1, it is satisfactory if at least either the port on the first level or the port on the second level is in the blocking state.

(A4) Procedure to Reduce Power Consumption in Network

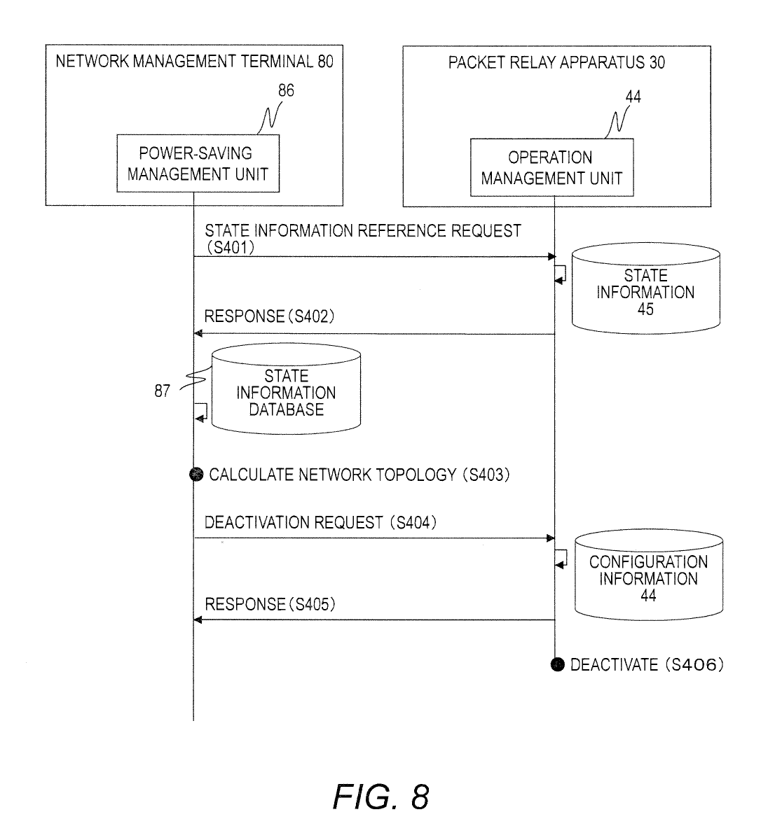

FIG. 8 is a sequence diagram illustrating a process flow for the network management terminal 80 to reduce the power consumption in the network to be managed. In each packet relay apparatus 30, an STP processing unit 41 and an LLDP processing unit 42 are working and hold the STP role of the packet relay apparatus 30, the STP roles of the packet transmission/reception ports 34, neighboring nodes of the packet transmission/reception ports 34, and the like as the state information 46. Furthermore, a statistics processing unit 43 is working in the packet relay apparatus 30 and holds CPU usage, traffic volume at each packet transmission/reception port 34, and the like as the state information 46.

The power-saving management unit 86 in the network management terminal 80 periodically, for example once per hour, accesses all of the packet relay apparatuses 30 to be managed (or the packet relay apparatuses 30 in a designated data center) to request them to refer to the STP information, LLDP information, and statistics information (Step S401).

Each packet relay apparatus 30 receives the request at the operation management unit 44. The operation management unit 44 acquires requested information from the state information 46 to respond to the network management terminal 80 (Step S402).

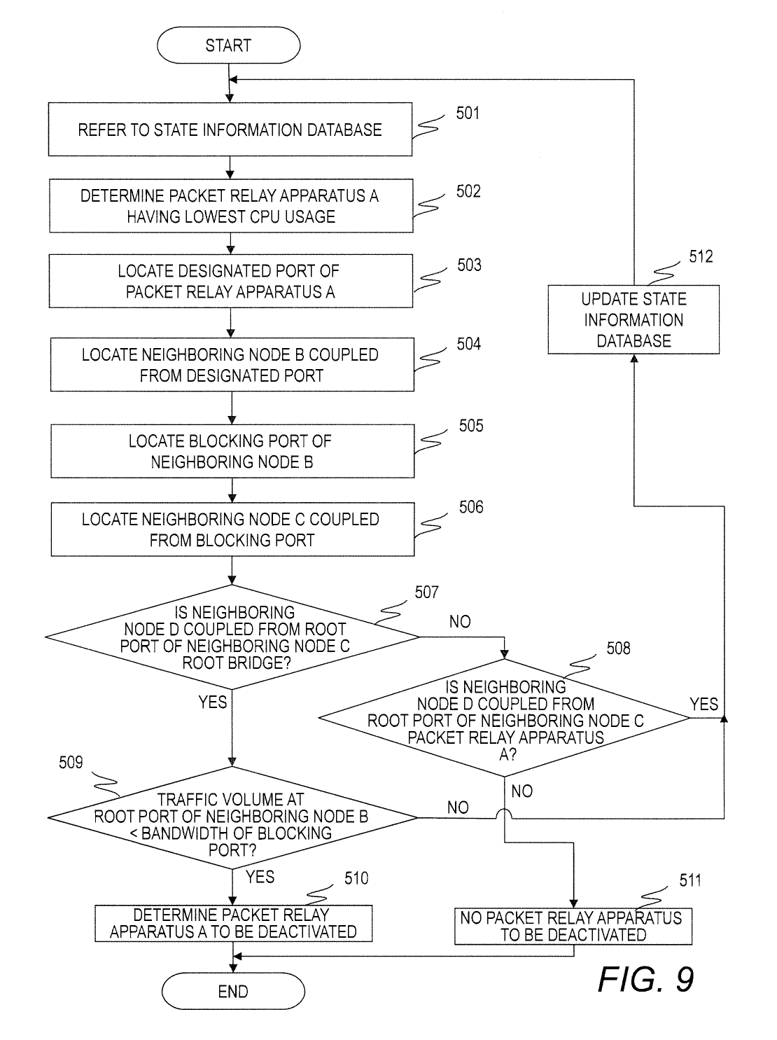

Upon receipt of the information, the power-saving management unit 86 in the network management terminal 80 saves the acquired information in the state information database 87. Upon completion of receiving the information from all the packet relay apparatuses 30 to be managed and saving it in the state information database 87, the power-saving management unit 86 in the network management terminal 80 calculates the network topology to extract a packet relay apparatus 30 that can be deactivated as shown in the flowchart of FIG. 9 (Step S403).

FIG. 9 is a flowchart illustrating an example of processing of the network management terminal 80.

In FIG. 9, the network management terminal 80 first accesses the state information database 87 (501) to determine the packet relay apparatus 30 having the lowest CPU usage (502). In the case of the state information database 87 of FIG. 6, the packet relay apparatus 30 having the lowest CPU usage is the packet relay apparatus 30b. It can be considered that this packet relay apparatus 30b will less affect the traffic in the network if it is deactivated because its CPU usage is lowest. Accordingly, the power-saving management unit 86 selects this packet relay apparatus 30b as a candidate to be deactivated (packet relay apparatus A).

Next, the power-saving management unit 86 in the network management terminal 80 refers to the state information database 87 to locate designated ports of the packet relay apparatus 30b (503). In the case of the state information database 87 of FIG. 6, the designated port of the packet relay apparatus 30b is the packet transmission/reception port b2. Inversely, the neighboring node (first neighboring node) coupled from the designated port b2 uses its port for this path as a root port and sends traffic to the root bridge via this path. Accordingly, to investigate the effect on the traffic using the designated port b2, the power-saving management unit 86 in the network management terminal 80 refers to the state information database 87 to locate the first neighboring node (neighboring node B in FIG. 9) coupled to the designated port b2 (504).

In the case of the state information database 87 of FIG. 6, the first neighboring node of the packet transmission/reception port b2 of the designated port is the packet relay apparatus 30e (lines 303 and 306). The packet relay apparatus 30e uses this path to send traffic to the root bridge.

Next, the power-saving management unit 86 in the network management terminal 80 refers to the state information database 87 to determine whether the packet relay apparatus 30e of the first neighboring node has a blocking port and if it has a blocking port, it locates the blocking port of the first neighboring node (505).

The power-saving management unit 86 further refers to the state information database 87 to locate the neighboring node (second neighboring node) coupled from the blocking port of the first neighboring node (506). In the case of the state information database 87 of FIG. 6, the packet relay apparatus 30e has a blocking port e3 (line 321) and the second neighboring node (neighboring node C in FIG. 9) coupled from the port e3 is the packet relay apparatus 30c (line 322).

Next, the power-saving management unit 86 refers to the state information database 87 to locate the third neighboring node (neighboring node D in FIG. 9) coupled from the root port of the packet relay apparatus 30c and determines whether the third neighboring node is the root bridge coupled from the root port of the second neighboring node (507). In the example of FIG. 1, the third neighboring node coupled from the root port of the packet relay apparatus 30c is the packet relay apparatus 30a, which functions as a root bridge. This means that the packet relay apparatus 30e has a path coupled to the root bridge beyond the blocking port. In this case, the packet relay apparatus 30e, which is coupled downstream (from the designated port b2) of the packet relay apparatus 30b having the lowest CPU usage, can access the root bridge of the third packet relay apparatus 30a from the blocking port e3 via the second packet relay apparatus 30c; accordingly, the power-saving management unit 86 proceeds to the next Step 509. As to the terms of upstream and downstream of a packet relay apparatus 30 in a data center 20, the direction toward the root bridge is defined as upstream and the direction toward the leaves where the computer 60 or the storage apparatus 70 are coupled is defined as downstream.

If the neighboring node cannot access the root bridge from the blocking port, the power-saving management unit 86 proceeds to Step 508. The power-saving management unit 86 determines whether the third neighboring node coupled from the root port of the second neighboring node is the packet relay apparatus A, which is the candidate to be deactivated (508). If the neighboring node is the packet relay apparatus of the candidate to be deactivated (YES at 508), the power-saving management unit 86 proceeds to Step 512 to update the state information database 87, and returns to Step 501 to repeat the foregoing processing until a new candidate to be deactivated appears.

If the neighboring node is not a candidate to be deactivated and there is no path coupled to the root bridge beyond the blocking port, the power-saving management unit 86 proceeds to Step 511 to determine that there is no packet relay apparatus 30 for the candidate to be deactivated and terminates the processing.

Through the foregoing processing, the power-saving management unit 86 has determined whether a packet relay apparatus 30 located downstream of the packet relay apparatus 30 having a low CPU usage can access the root bridge if it sends traffic from a blocking port (507). The power-saving management unit 86 which has determined that the root bridge is reachable next determines whether the bandwidth of the path using the blocking port of the foregoing downstream packet relay apparatus might cause overflow when the current traffic flowing through the root port is switched to the blocking port (509).

In the case of this embodiment, the power-saving management unit 86 compares the traffic volume at the root port e1 of the packet relay apparatus 30e located downstream of the candidate to be deactivated with the bandwidth of the blocking port e3 coupled to the packet relay apparatus 30c and if it determines that bandwidth overflow will not occur, it proceeds to Step 510.

If the traffic volume at the root port e1 of the packet relay apparatus 30e exceeds the bandwidth of the blocking port e3 coupled to the packet relay apparatus 30c, overflow will occur. The power-saving management unit 86 proceeds to Step 512 to update the state information database 87, and repeats the foregoing processing.

At Step 510, the power-saving management unit 86 selects the candidate to be deactivated, the packet relay apparatus 30b having a low CPU usage, as the packet relay apparatus to be deactivated. Then, the power-saving management unit 86 changes the blocking port of the packet relay apparatus 30e, which is located downstream of the packet relay apparatus 30b to be deactivated, into a root port.

Next, at Step S404 in FIG. 8, the power-saving management unit 86 requests for deactivation of the packet relay apparatus 30b having the low CPU usage selected to be deactivated. In this embodiment, the power-saving management unit 86 sends an instruction to change the blocking port e3 of the packet relay apparatus 30e to a root port and deactivate the packet relay apparatus 30b.

When the power-saving management unit 86 in the network management terminal 80 receives a response to the instruction for deactivation from the packet relay apparatus 30b (S405), it updates the information concerning STP and LLDP in the state information database 87 and terminates the processing.

Repeating the foregoing processing to release a path in a blocking state enables deactivation of a packet relay apparatus 30 wasting power in the network, which reduces the power consumption in the network. The foregoing processing under a network environment where STP is functioning can prevent generation of a loop, while reducing the power consumption in the network without serious effect on the traffic flow in the network.

The above-described embodiment provided an example that the power-saving management unit 86 returns to Step 501 after updating the state information database 87 if the packet relay apparatus 30e located downstream the candidate to be deactivated, the packet relay apparatus 30b, cannot access the root bridge of the third packet relay apparatus 30a from the blocking port e3, or if the bandwidth of this path causes overflow. However, the processing is not limited to this. For example, if the packet relay apparatus 30e located downstream of the candidate to be deactivated cannot access the root bridge from the blocking port e3, the power-saving management unit 86 may terminate the processing and restart the processing of FIGS. 8 and 9 after a certain time period.

The above-described example of FIG. 9 provided an example that refers to the CPU usages of the packet relay apparatuses 30 to select a candidate to be deactivated; however, the procedure is not limited to this. A candidate packet relay apparatus 30 to be deactivated may be selected based on the traffic volume, the number of sessions, or the number of flows.

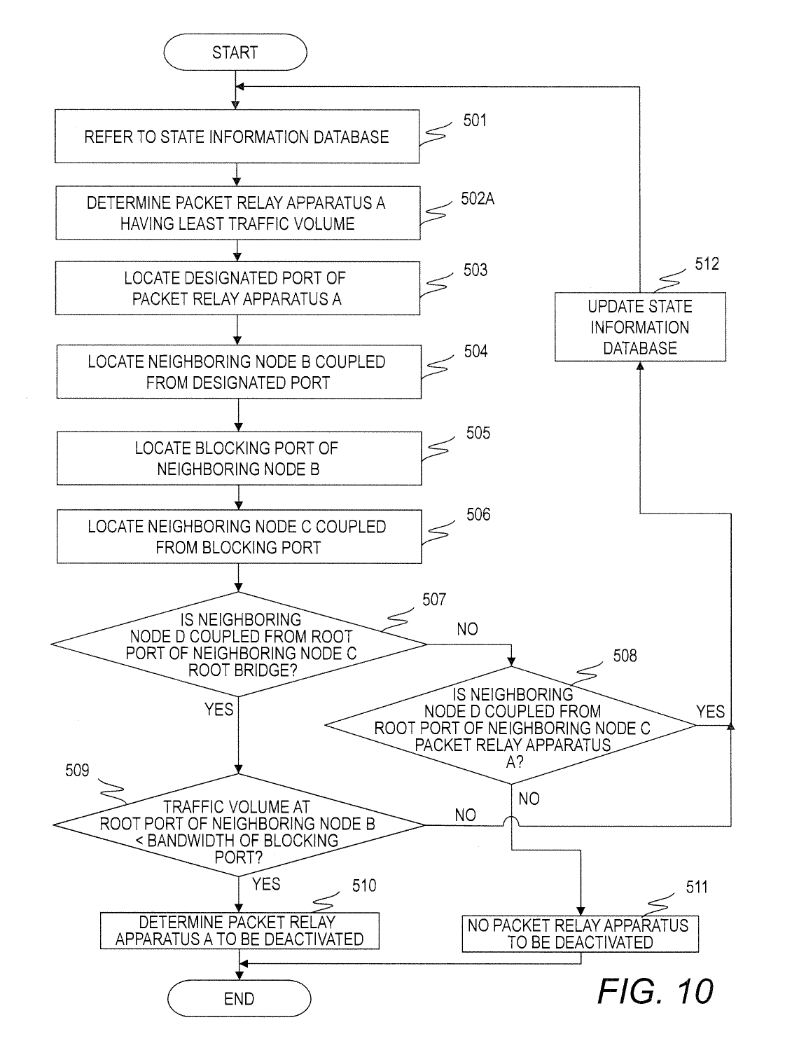

In the case of referring to the traffic volume, the power-saving management unit 86 locates the packet relay apparatus 30 having the least total traffic volume (the sum of the transmission traffic volume and the reception traffic volume) with reference to the state information database 87 to determine it to be the candidate to be deactivated. That is to say, Step 502 in FIG. 9 should be changed to selecting a packet relay apparatus 30 having the least total traffic volume as a candidate to be deactivated, as illustrated in Step 502A in FIG. 10.

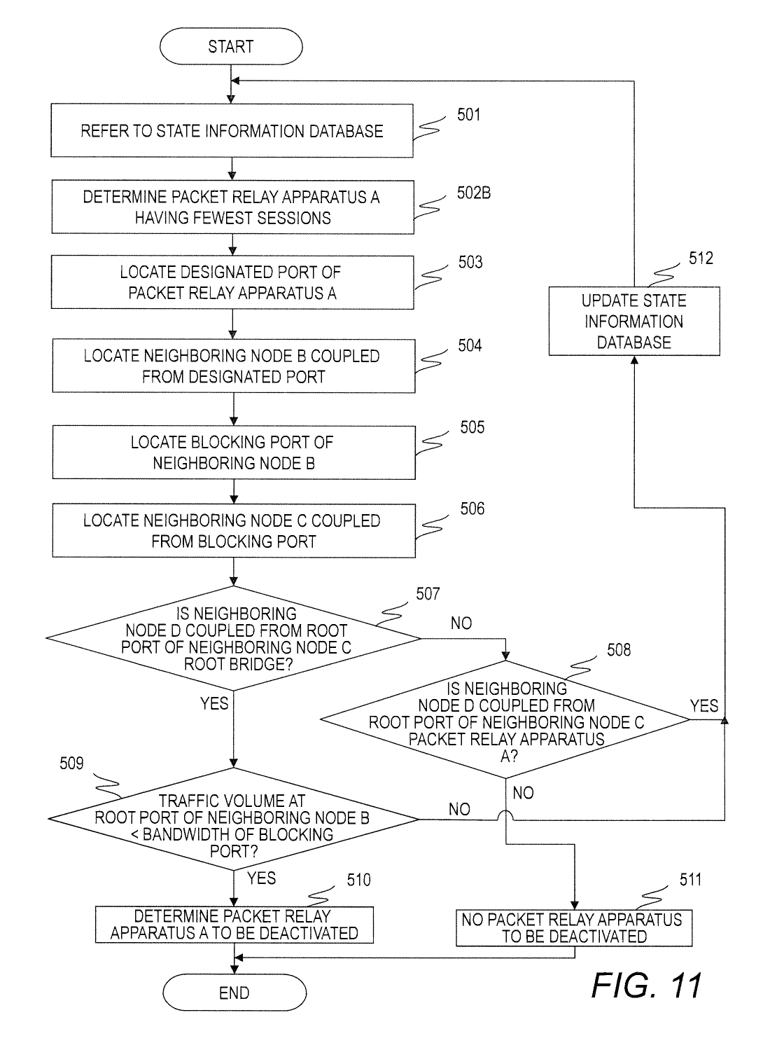

In the case of referring to the number of sessions, the power-saving management unit 86 locates the packet relay apparatus 30 having the smallest number of sessions with reference to the state information database 87 to determine it to be the candidate to be deactivated. That is to say, Step 502 in FIG. 9 should be changed to selecting a packet relay apparatus 30 having the fewest sessions as a candidate to be deactivated, as illustrated in Step 502B in FIG. 11.

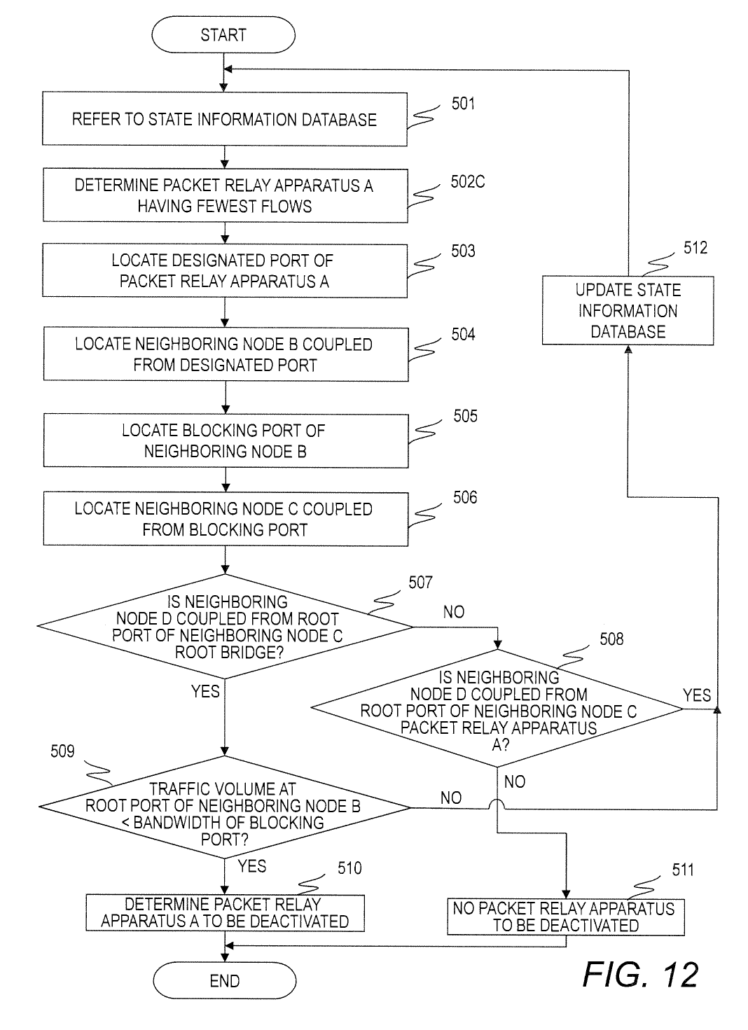

In the case of referring to the number of flows, the power-saving management unit 86 locates the packet relay apparatus 30 having the smallest number of flows with reference to the state information database 87 to determine it to be the candidate to be deactivated. That is to say, Step 502 in FIG. 9 should be changed to selecting a packet relay apparatus 30 having the fewest flows as a candidate to be deactivated, as illustrated in Step 502C in FIG. 12.

This invention can be configured as a network management method or a computer program to be executed in a network management terminal, in addition to the above-described system including the packet relay apparatuses 30 and the network management terminal 80. The computer program may be stored in a computer-readable storage medium. Examples of the storage medium include various media: a floppy disk, a CD-ROM, a DVD-ROM, a magnetic optical disc, a memory card, and a hard disk.

Embodiments of this invention have now been described. However, this invention is not limited to the embodiments described above, and it would be easy for those skilled in the art to modify, add, or convert elements of the embodiments described above within the scope of this invention. For instance, a system or an apparatus to which this invention is applied can have only a part of the configurations of the plurality of embodiments described above, or can include all components of the plurality of embodiments described above. This invention allows for substituting some elements of the configuration of one embodiment with elements of another embodiment, and allows for adding a part of the configuration of one embodiment to another embodiment.

What is claimed is:

1. A network management system comprising:
a network including a plurality of packet relay apparatuses; and
a management computer for managing the plurality of packet relay apparatuses,
wherein the plurality of packet relay apparatuses include first packet relay apparatuses, second packet relay apparatuses, and third packet relay apparatuses located downstream of the first packet relay apparatuses and the second packet relay apparatuses,
wherein each of the third packet relay apparatuses has a first path coupled to one of the first packet relay apparatuses to send and receive traffic and a second path coupled to one of the second packet relay apparatuses and being in a blocking state,
wherein the management computer includes:
a state information collection unit for acquiring state information on the first to the third packet relay apparatuses; and
a power management unit for selecting a candidate packet relay apparatus to be deactivated satisfying predetermined conditions based on the state information as a first packet relay apparatus to be deactivated out of the first packet relay apparatuses which can be deactivated when using the second path in the blocking state to transmit the traffic, deactivating the first packet relay apparatus to be deactivated, releasing the second path in the blocking state between the third packet relay apparatus and the second packet relay apparatus for the first packet relay apparatus to switch sending and receiving the traffic to the second path.

2. The network management system according to claim 1,
wherein the network couples the second packet relay apparatuses and the third packet relay apparatuses via blocking ports based on Spanning Tree Protocol, and
wherein the power management unit releases blocking ports of the third packet relay apparatus and the second packet relay apparatus for the first relay apparatus to switch sending and receiving the traffic to the second path.

3. The network management system according to claim 2,
wherein each of the first to the third packet relay apparatuses includes a CPU for computing, and a statistics processing unit for acquiring a CPU usage and a traffic volume,
wherein the state information collection unit acquires the CPU usages and the traffic volumes of the first to the third packet relay apparatuses as state information, and
wherein the power management unit selects the candidate packet relay apparatus to be deactivated as the packet relay apparatus to be deactivated in a case where the candidate packet relay apparatus is a first packet relay apparatus having a lowest CPU usage among the first packet relay apparatuses and the second packet relay apparatus for the candidate first packet relay apparatus is able to carry the traffic volume of the candidate first packet relay apparatus.

4. The network management system according to claim 2,
wherein each of the first to the third packet relay apparatuses includes a statistics processing unit for acquiring a traffic volume,
wherein the state information collection unit acquires the traffic volumes of the first to the third packet relay apparatuses as state information, and
wherein the power management unit selects the candidate packet relay apparatus to be deactivated as the packet relay apparatus to be deactivated in a case where the candidate packet relay apparatus is a first packet relay apparatus having a least traffic volume among the first packet relay apparatuses and the second packet relay apparatus for the candidate first packet relay apparatus is able to carry the traffic volume of the candidate first packet relay apparatus.

5. The network management system according to claim 2,
wherein each of the first to the third packet relay apparatuses includes a statistics processing unit for acquiring the number of sessions and a traffic volume,
wherein the state information collection unit acquires the numbers of sessions and the traffic volumes of the first to the third packet relay apparatuses as state information, and
wherein the power management unit selects the candidate packet relay apparatus to be deactivated as the packet relay apparatus to be deactivated in a case where the candidate packet relay apparatus is a first packet relay apparatus having a smallest number of sessions among the first packet relay apparatuses and the second packet relay apparatus for the candidate first packet relay apparatus is able to carry the traffic volume of the candidate first packet relay apparatus.

6. The network management system according to claim 2,
wherein each of the first to the third packet relay apparatuses includes a statistics processing unit for acquiring the number of flows and a traffic volume,
wherein the state information collection unit acquires the numbers of flows and the traffic volumes of the first to the third packet relay apparatuses as state information, and
wherein the power management unit selects the candidate packet relay apparatus to be deactivated as the packet relay apparatus to be deactivated in a case where the candidate packet relay apparatus is a first packet relay apparatus having a smallest number of flows among the first packet relay apparatuses and the second packet relay apparatus for the candidate first packet relay apparatus is able to carry the traffic volume of the candidate first packet relay apparatus.

7. A network management computer for managing a network including a plurality of packet relay apparatuses, the management computer comprising:
a packet relay apparatus configuration unit for managing the plurality of packet relay apparatuses including first packet relay apparatuses, second packet relay apparatuses, and third packet relay apparatuses located downstream of the first packet relay apparatuses and the second packet relay apparatuses, each of the third packet relay apparatuses having a first path coupled to one of the first packet relay apparatuses to send and receive traffic and a second path coupled to one of the second packet relay apparatuses and being in a blocking state,
a state information collection unit for acquiring state information on the first to the third packet relay apparatuses; and
a power management unit for selecting a candidate packet relay apparatus to be deactivated satisfying predetermined conditions based on the state information as a first packet relay apparatus to be deactivated out of the first packet relay apparatuses which can be deactivated when using the second path in the blocking state to transmit the traffic, deactivating the first packet relay apparatus to be deactivated, releasing the second path in the blocking state between the third packet relay apparatus and the second packet relay apparatus for the first packet relay apparatus to switch sending and receiving the traffic to the second path.

8. The network management computer according to claim 7,
wherein the network couples the second packet relay apparatuses and the third packet relay apparatuses via blocking ports based on Spanning Tree Protocol, and
wherein the power management unit releases blocking ports of the third packet relay apparatus and the second packet relay apparatus for the first relay apparatus to switch sending and receiving the traffic to the second path.

9. The network management computer according to claim 8,
wherein the state information collection unit acquires CPU usages and traffic volumes of the first to the third packet relay apparatuses as state information, and
wherein the power management unit selects the candidate packet relay apparatus to be deactivated as the packet relay apparatus to be deactivated in a case where the candidate packet relay apparatus is a first packet relay apparatus having a lowest CPU usage among the first packet relay apparatuses and the second packet relay apparatus for the candidate first packet relay apparatus is able to carry the traffic volume of the candidate first packet relay apparatus.

10. The network management computer according to claim 8,
wherein the state information collection unit acquires traffic volumes of the first to the third packet relay apparatuses as state information, and
wherein the power management unit selects the candidate packet relay apparatus to be deactivated as the packet relay apparatus to be deactivated in a case where the candidate packet relay apparatus is a first packet relay apparatus having a least traffic volume among the first packet relay apparatuses and the second packet relay apparatus for the candidate first packet relay apparatus is able to carry the traffic volume of the candidate first packet relay apparatus.

11. The network management computer according to claim 8,
wherein the state information collection unit acquires the numbers of sessions and traffic volumes of the first to the third packet relay apparatuses as state information, and
wherein the power management unit selects the candidate packet relay apparatus to be deactivated as the packet relay apparatus to be deactivated in a case where the candidate packet relay apparatus is a first packet relay apparatus having a smallest number of sessions among the first packet relay apparatuses and the second packet relay apparatus for the candidate first packet relay apparatus is able to carry the traffic volume of the candidate first packet relay apparatus.

12. The network management computer according to claim 8,
wherein the state information collection unit acquires the numbers of flows and traffic volumes of the first to the third packet relay apparatuses as state information, and
wherein the power management unit selects the candidate packet relay apparatus to be deactivated as the packet relay apparatus to be deactivated in a case where the candidate packet relay apparatus is a first packet relay apparatus having a smallest number of flows among the first packet relay apparatuses and the second packet relay apparatus for the candidate first packet relay apparatus is able to carry the traffic volume of the candidate first packet relay apparatus.

13. A network management method of managing a network including a plurality of packet relay apparatuses with a management computer,
the plurality of packet relay apparatuses including first packet relay apparatuses, second packet relay apparatuses, and third packet relay apparatuses located downstream of the first packet relay apparatuses and the second packet relay apparatuses,
each of the third packet relay apparatuses having a first path coupled to one of the first packet relay apparatuses to send and receive traffic and a second path coupled to one of the second packet relay apparatuses and being in a blocking state,
the management method comprising the steps of:
a first step of acquiring state information on the first to the third packet relay apparatuses;
a second step of selecting a candidate packet relay apparatus to be deactivated satisfying predetermined conditions based on the state information as a first packet relay apparatus to be deactivated out of the first packet relay apparatuses which can be deactivated when using the second path in the blocking state to transmit the traffic;
a third step of deactivating the first packet relay apparatus to be deactivated; and
a fourth step of releasing the second path in the blocking state between the third packet relay apparatus and the second packet relay apparatus for the first packet relay apparatus to switch sending and receiving the traffic to the second path.

14. The network management method according to claim 13,
wherein the network couples the second packet relay apparatuses and the third packet relay apparatuses via blocking ports based on Spanning Tree Protocol, and
wherein the fourth step releases blocking ports of the third packet relay apparatus and the second packet relay apparatus for the first relay apparatus to switch sending and receiving the traffic to the second path.
